(19) United States
(12) Patent Application Publication
(10) Pub. No.: US 2012/0098327 A1
(43) Pub. Date: Apr. 26, 2012

(54) Track chain running gear for mining machines, and chain link for a track chain running gear and method for producing said chain link

(75) Inventor: Kurt Schaffer, Seckau (AT)

(73) Assignee: Sandvik Mining and Construction G.m.b.H, Zeltweg (AT)

(21) Appl. No.: 13/382,636

(22) PCT Filed: Jul. 8, 2010
(86) PCT No.: PCT/AT2010/000251

§ 371 Date: Jan. 6, 2012

(30) Foreign Application Priority Data
Jul. 9, 2009 (AT) A 1080/2009

(51) Int. Cl. B62D 55/26

(52) U.S. Cl. 305/185

(57) ABSTRACT

In a track chain running gear (2) for mining machines (1), in particular heading machines, including at least one running gear case (5) and a track chain running around the running gear case (5) and formed by a multiplicity of chain links (3) articulately connected to one another, the running gear case (5), on its side facing the roadway, carries sliding plates (6) that form contact surfaces for the chain links (3) running along them, wherein the chain links (3), on their sides facing the sliding plates (6), carry wear plates (7) whose projecting surfaces cooperate with the contact surfaces of the sliding plates (6). In a chain link (3) for a track chain running gear (2), the chain link (3), on its side facing the sliding plates (6) of the running gear case (5), carries wear plates (7) whose projecting surfaces cooperate with the contact surfaces of the sliding plates (6). In a method for producing chain links (3) of a track chain running gear (2) wear plates (7) are inserted into a casting die for the chain link (3), and the chain link (3) is subsequently produced by casting, wherein the wear plates (7) inserted in the casting die are cast around such that the wear plates (7) project beyond the surface of the chain link (3) after the casting procedure. (FIG. 5)

The invention relates to a track chain running gear for mining machines, in particular heading machines, including at least one running gear case and a track chain running around the running gear case and formed by a multiplicity of chain links articulately connected to one another, wherein the running gear case, on its side facing the roadway, carries sliding plates that form contact surfaces for the chain links running along them. The invention further relates to chain links for a track chain running gear of the initially defined kind, and a method for producing chain links of a track chain running gear.

In underground mining, track chain running gears are frequently used to move the mining machines, since they would better distribute the large weights of the mining machines on the underlying surface than, for instance, wheels, thus enabling the reaction forces occurring during cutting or hewing to be more readily diverted into the floor. It is, however, exactly in underground mining that track chain running gears are prone to particularly high wear, since, on the one hand, mining machines have to be built very massively thus having accordingly high weight and, on the other hand, the dust forming during operation leads to a high wear of the track chain running gear due to its abrasive properties. In order to reduce the wear phenomena and improve the running properties of the chain links, running gear cases carrying sliding plates on their sides facing the roadway have, therefore, already been proposed, which sliding plates form contact surfaces for the chain links running along them. Such a configuration also provides an enhanced pressure distribution as compared to an arrangement of supporting or guiding rollers between the running gear case and the track chain. This is because the individual chain links are supported on the large-area sliding plates rather than on supporting or guiding rollers, which would result in a line contact and an accordingly high punctual load. Yet, a relatively high wear rate between chain links and sliding plates is still to be observed in such a configuration, thus calling for frequent maintenance of track chain running gears and, hence, reducing the service lives of mining machines.

From DE-A1 1960856 and EP-A2 078 635, track chain running gears are known, in which removable rubber inserts are provided to improve the wear behaviour.

U.S. Pat. No. 3,955,855 and U.S. Pat. No. 3,972,570 demonstrate that narrow wear inserts are glued into milled depressions of track link grousers or to the contact surfaces with the supporting rollers. Tungsten carbides having different ductile matrix materials are used as materials.

It is the objective of the invention to extend the service lives of track chain running gears while, at the same time, reducing the down times of vehicles equipped with the track chain running gears according to the invention. The invention, in particular, aims to configure the track chain running gear with the track link chain in such a manner as to provide a substantially enhanced protection against the wear of individual components of the track chain running gear, and hence render the machine more suitable for use in abrasive rock.

To solve this object, it is provided according to the invention that the chain links, on their sides facing the sliding plates, carry wear plates whose projecting surfaces cooperate with the contact surfaces of the sliding plates. By the projecting surfaces of the, particularly metallic, wear plates cooperating with the contact surfaces of the, particularly metallic, sliding plates, the friction, and hence the wear, between the chain links and the sliding plates are minimized. Since, during movement, only the wear and the sliding plates come into mutual contact, the wear properties can be influenced by a suitable selection of the material for the wear plates, wherein hard materials are particularly qualified for the wear plates, thus increasing their service lives even in highly abrasive rock.

In a preferred manner, wear or abrasion can be reduced in that the contact surfaces of the sliding plates and the wear plate surfaces projecting toward the sliding plates are configured as mutually cooperating, plane surfaces.

In a preferred manner, the track chain running gear is further developed to the effect that the wear plates are cast into the chain links. It will thereby be safeguarded that the wear plates will not come off the chain links, and keep their positions relative to the sliding plates, during travelling.

To increase the service lives of the wear plates, the track chain running gear in a preferred manner is further developed to the effect that the wear plates each comprise a carrier layer and a wear protection layer harder than the carrier layer, said wear protection layer preferably comprising a carbide reinforcement, wherein tungsten and chromium carbides are preferably distributedly arranged in an Ni-rich support matrix.

In a particularly preferred manner, the carrier layer is formed by a sheet metal having a thickness of preferably 3 to 8 mm and, in particular, 5 mm.

Due to the fact that, in a preferred manner, each chain link comprises at least two, in particular three, wear plates on its side facing the sliding plates, the abutment surface between the sliding plates and the wear plates will be increased with different chain link shapes, wherein it is to be taken care that the wear plates, if possible, are disposed relatively centrally on the chain links, or symmetrically relative to the longitudinal central plane of the chain links, in order to prevent tilting and a thus resulting unilateral abrasion.

A chain link for a track chain running gear of the invention, in accordance with the invention is characterized in that the chain link, on its side facing the sliding plates of the running gear case, carries wear plates whose projecting surfaces cooperate with the contact surfaces of the sliding plates. In that the projecting surfaces of the wear plates are preferably designed as plane surfaces, the abrasion will be reduced.

To fix the wear plates to the chain link, the wear plates are preferably cast into the chain link.

To ensure a more cost-effective production of the chain links, the chain link is preferably further developed to the effect that the wear plates each comprise a carrier layer and a wear protection layer harder than the carrier layer. It is consequently unnecessary to make the entire wear plate of the harder and accordingly more expensive wear protection layer material.

In a preferred manner, the wear protection layer comprises a carbide reinforcement, wherein tungsten and chromium carbides are preferably distributedly arranged in an Ni-rich support matrix.

In a preferred manner, the chain link is further developed to the effect that the carrier layer is formed by a sheet metal having a thickness of preferably 3 to 8 mm and, in particular, 5 mm. The use of a sheet metal as carrier layer, on the one hand, reduces the costs of the wear plate in a simple manner and, on the other hand, enables the sheet metal to be melted onto the wear plate on its outer contours when casting around the wear plate by steel casting.

For a better load distribution, it is provided in a preferred manner that each chain link comprises at least two, in particular three, wear plates on its side facing the sliding plates.

In the method according to the invention for producing chain links of a track chain running gear, it is proceeded in such a manner that wear plates are inserted into a casting die for the chain link, and the chain link is subsequently produced by casting, wherein the wear plates inserted in the casting die are cast around such that the wear plates project beyond the surface of the chain link after the casting procedure. In doing so, the chain link is, for instance, produced of the material 42CrMo4. Since the wear plates are cast into the chain link in a simple manner, a permanent connection between the chain link and the wear plate is produced, which will not come loose even under heavy loads, wherein, in a particularly preferred manner, the method is carried out such that the wear plates are cast in so as to project beyond the surface of the chain link by 15 to 50%, preferably 20 to 30%, of their overall thicknesses.

In that the wear plate to be cast in is preferably comprised of a carrier layer of sheet metal and a wear protection layer provided thereon, the outer contour of the carrier layer is incipiently melted when casting around the wear plate. At the same time, the wear protection layer is melted open so as to penetrate into the jointing gap between the carrier layer and the steel casting of the chain link during casting around, thus providing a permanent connection.

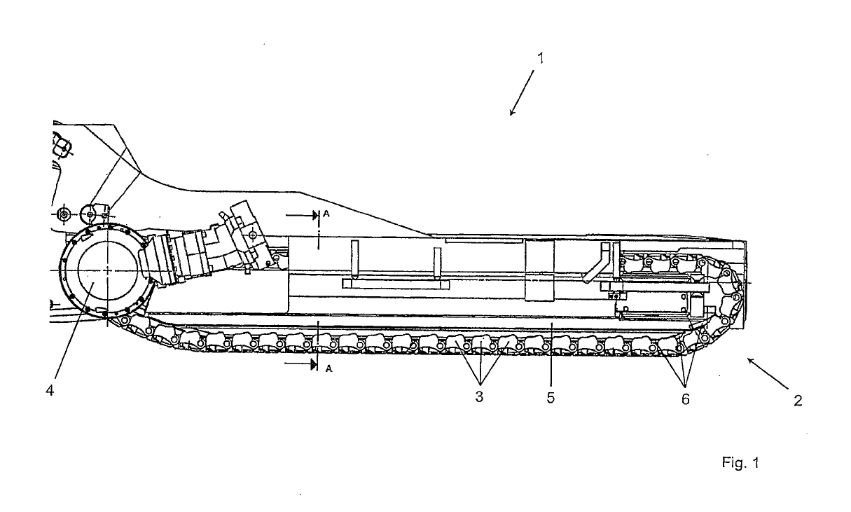

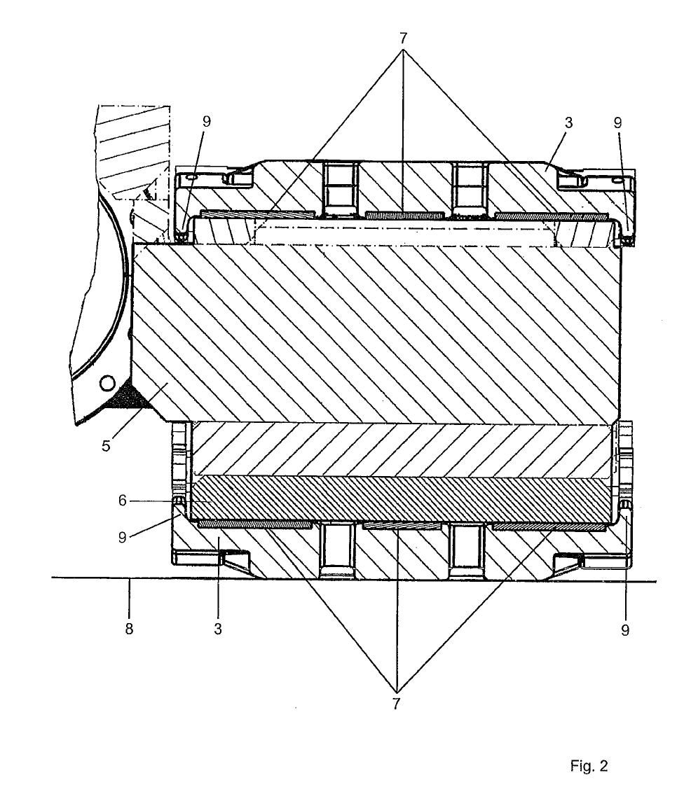

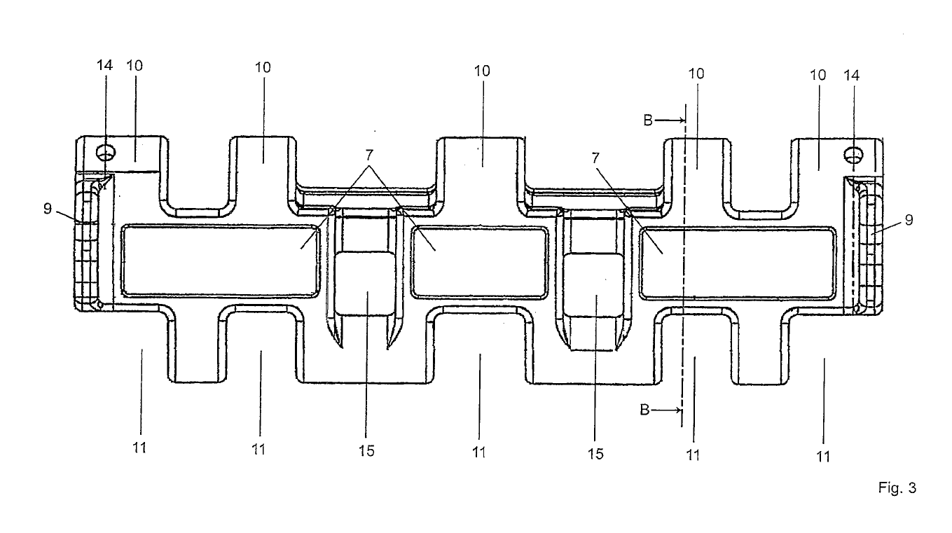

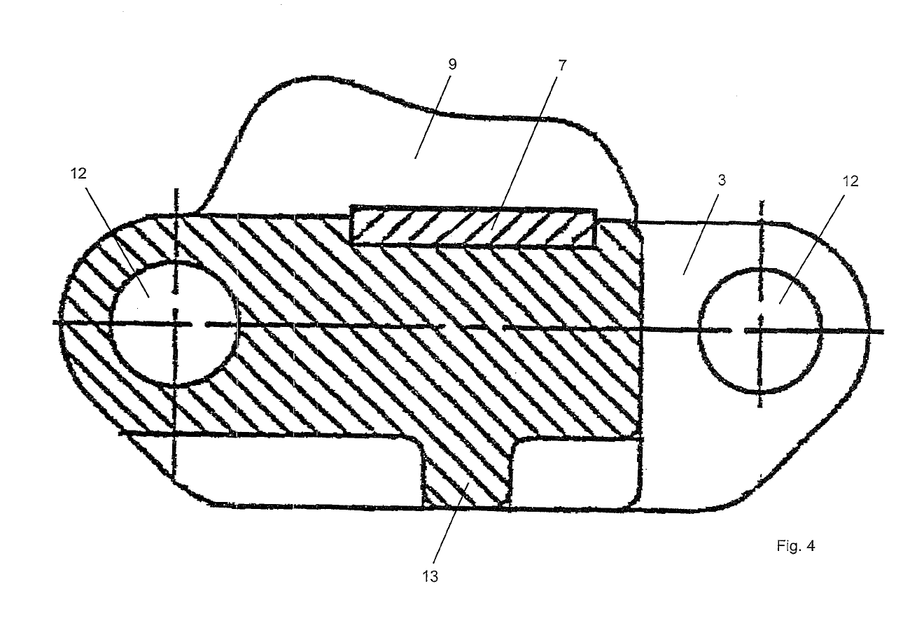

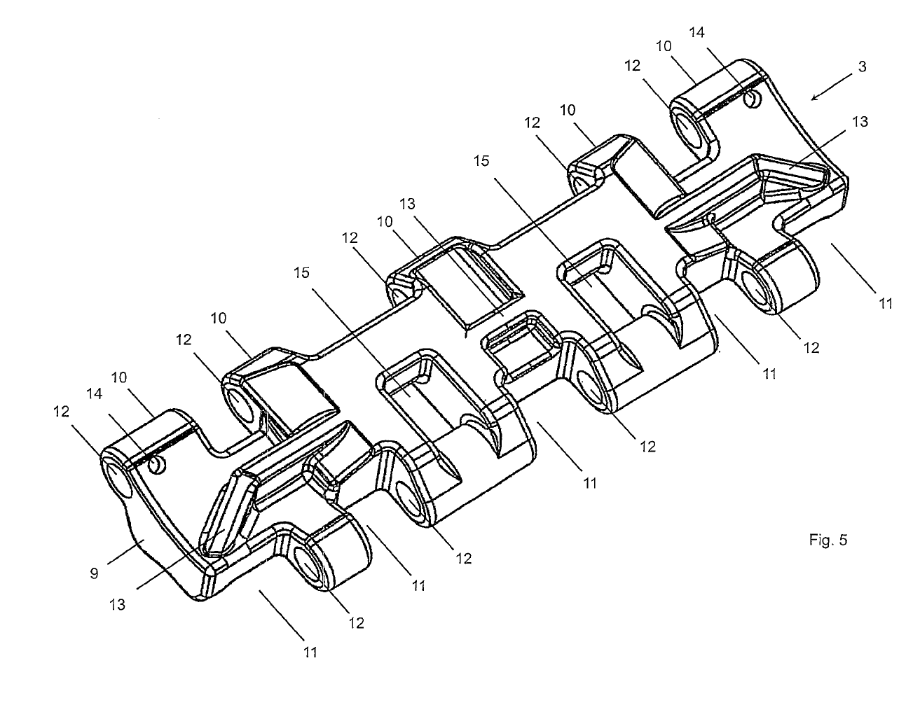

In the following, the invention will be explained in more detail by way of an exemplary embodiment schematically illustrated in the drawing. Therein, FIG. 1 shows a side view of a track chain running gear fastened to the base frame of a heading machine; FIG. 2 depicts a sectional view along line A-A of FIG. 1; FIG. 3 is a ground plan of a track chain link; FIG. 4 depicts a sectional view along line B-B of FIG. 3; and FIG. 5 is an oblique view of a track chain link.

In FIG. 1, a heading machine is denoted by 1, which carries a track chain running gear denoted by 2. The track chain running gear 2 is comprised of a chain including a plurality of chain links 3 which, driven by a hydraulic drive 4, are moved around a running gear case 5 to move the heading machine 1. On the contact surface between the chain links and the running gear case, the total weight of the machine is transmitted to the chain links with the highest wear occurring there, which is why sliding plates 6 are disposed between the chain links 3 and the running gear case 5.

FIG. 2 shows a section along line A-A of FIG. 1, from which the sliding plate 6 is more clearly visible on the underside of the running gear case 5. On their sides facing the sliding plates 6, the chain links carry wear plates 7. On the upper side of the running gear case 5, sliding plates 6 may also be disposed to reduce the friction between the chain links 3 and the running gear case 5. The floor is denoted by 8. The chain links 3 carry lateral projections 9 extending in the longitudinal direction of the running gear case 5 to prevent abrasive material and, in particular, larger rock pieces from entering between the chain links 3 and the sliding plates 6.

FIG. 3 depicts a chain link 3 in ground plan, showing its side facing the sliding plates 6. Three wear plates 7 are to be seen. To produce a chain of such chain links 3, the projections 10 of a chain link 3 are simply introduced into the recesses 11 of an adjacent chain link 3, and the chain links 3 are pivotally connected to one another by a pin (not illustrated), which is introduced transversely to the insertion direction in the plane of the chain link. The pin can be prevented from sliding out by the aid of securing elements inserted in openings 14.

FIG. 4 illustrates a section along line B-B of FIG. 3, wherein identical components are denoted by the same reference numerals. From this illustration, two bores 12 are apparent, in which a pin can each be received to hold the chain links together. A web that serves to increase the traction is denoted by 13.

From the oblique view according to FIG. 5, the side of a chain link 3, that faces away from the running gear case 5 is apparent. In this Figure, the course of the webs 13 is readily recognizable. Openings 15 serve to remove abrasive material that has entered between the chain links and the running gear case. At the same time, the openings 15 also serve the engagement of the hydraulic drive 4. In order to reduce wear, wear plates 7 may also be cast into the outer sides of the chain links, in which case it is to be taken care that the required traction will nevertheless be applied on the floor.

1. A track chain running gear (2) for mining machines (1), in particular heading machines, including at least one running gear case (5) and a track chain running around the running gear case (5) and formed by a multiplicity of chain links (3) articulately connected to one another, wherein the running gear case (5), on its side facing the roadway, carries sliding plates (6) that form contact surfaces for the chain links (3) running along them, and via which sliding plates the weight of the machine can be transmitted to the chain links, characterized in that the chain links (3), on their sides facing the sliding places (6), carry wear plates (7) whose projecting surfaces cooperate with the contact surfaces of the sliding plates (6).

2. A track chain running gear according to claim 1, characterized in that the wear plates (7) and optionally the sliding plates (6) are made of metal.

3. A track chain running gear according to claim 1, characterized in that the contact surfaces of the sliding plates (6) and the wear plate (7) surfaces projecting toward the sliding plates (6) are designed as mutually cooperating, plane surfaces.

4. A track chain running gear according to claim 1, characterized in that the wear plates (7) are cast into the chain links (3).

5. A track chain running gear according to claim 1, characterized in that the wear plates (7) each comprise a carrier layer and a wear protection layer harder than the carrier layer.

6. A track chain running gear according to claim 5, characterized in that said wear protection layer comprises a carbide reinforcement, wherein tungsten and chromium carbides are preferably distributedly arranged in an Ni-rich support matrix.

7. A track chain running gear according to claim 5, characterized in that the carrier layer is formed by a sheet metal having a thickness of 3 to 8 mm.

8. A track chain running gear according to claim 1, characterized in that each chain link (3) comprises at least two, in particular three, wear plates (7) on its side facing the sliding plates (6).

9. A chain link for a track chain running gear according to claim 1, wherein the chain link (3), on its side facing the sliding plates (6) of the running gear case (5), carries wear plates (7) whose projecting surfaces cooperate with the contact surfaces (3) of the sliding plates (6), characterized in that the wear plates (7) comprise a carrier layer and a wear protection layer harder than the carrier layer.

10. A chain link according to claim 9, characterized in that the projecting surfaces of the wear plates (7) are configured as plane surfaces.

11. A chain link according to claim 9, characterized in that the wear plates (7) are cast into the chain link (3).

12. A chain link according to claim 9, characterized in that said wear protection layer comprises a carbide reinforcement, wherein tungsten and chromium carbides are preferably distributedly arranged in an Ni-rich support matrix.

13. A chain link according to claim 9, characterized in that the carrier layer is formed by a sheet metal having a thickness of 3 to 8 mm.

14. A chain link according to claim 9, characterized in that each chain link (3) comprises at least two wear plates (7) on its side facing the sliding plates (6).

15. A track chain running gear according to claim 5, characterized in that the carrier layer is formed by a metal sheet having a thickness of 5 mm.

16. A chain link according to claim 9, characterized in that the carrier layer is formed by a metal sheet having a thickness of 5 mm.

17. A chain link according to claim 9, characterized in that each chain link comprises three wear plates (7) on its side facing plates (6).
